(19) United States
(12) Patent Application Publication
(10) Pub. No.: US 2003/0120522 A1
(43) Pub. Date: Jun. 26, 2003

(54) Vehicle monitoring and reservation system

(76) Inventor: Robert Uyeki, Torrance, CA (US)

Correspondence Address: David J. Meyer, Manatt, Phelps & Phillips, LLP, 11355 W. Olympic Blvd., Los Angeles, CA, 90064, US

(21) Appl. No.: 10/027,370

(22) Filed: Dec. 20, 2001

(51) Int. Cl. G06F 17/60

(52) U.S. Cl. 705/5

(57) ABSTRACT

The invention provides a vehicle monitoring and reservation system for use in a shared vehicle system. The vehicle monitoring and reservation system provide that a vehicle is tracked by a central computer in order to accurately gage when a vehicle will be able to be reallocated to another user, thereby making multiple use of a vehicle within a given fleet of shared vehicles. The invention includes tracking the vehicles through the use of vehicle monitoring devices including Global Positioning System (GPS), geo-fencing, and user-input information.

### BACKGROUND OF THE INVENTION

1. Field of the Invention

The present invention relates to a vehicle monitoring and reservation system usable in allocating a vehicle from a fleet of shared vehicles.

2. Description of the Related Art

The need to efficiently allocate vehicles has arisen as different models of vehicle sharing develop. The typical rental car experience is well known. Whereby a user enters a vehicle rental facility and contracts to exclusively use an available vehicle for a determined period of time. Additional models of ownership free vehicle use (shared-vehicle systems) include vehicle sharing systems and what are described as “station cars.”

The premise of vehicle sharing is simple. Individuals gain the benefits of private car use without the costs and responsibilities of ownership, while society benefits from more efficient vehicle usage. More specifically, vehicle sharing allows a household to access, as needed, a fleet of shared-use vehicles. Vehicle sharing may be thought of as organized short-term car rental. Generally, participants pay a usage fee each time they use a vehicle.

Vehicle sharing might take a variety of forms. It might be neighborhood based, catering to residents who use the vehicles for short round trips to pick up goods and travel to social and recreational activities; it might jointly serve individuals commuting to work or school in peak hours and fleets during work hours; it might serve tourists or second-home residents; or it might be a complex multi-nodal regional system serving millions.

The station car concept is slightly different, however the distinctions between it and vehicle sharing are becoming blurred as the two methods begin to share the positive aspects of each system thereby merging into a single shared-vehicle model. For example both shared-vehicle systems require similar reservation and billing systems, fleet management systems, vehicle access systems, insurance, vehicles, and other hardware and software. In addition, the success of both systems relies on their ability to effectively make multiple uses of the vehicles within the fleet at all times. The multiple use aspect of the vehicles allows for the economic viability of the system and creates the largest societal advantage given fewer vehicles are used to handle the same user transportation requirements.

As an illustration, consider the traveler returning from work at the end of the day. She rents a shared-use vehicle (vehicle 1) at a transit station or other rental site close to home; she then conducts various errands and drives home. In the morning she drives to the same or different transit station where she leaves the vehicle; she then rides a bus or train to a station near her office where she “rents” another vehicle (vehicle 2) to complete her commute at her place of business parking lot. During the day, vehicle 2, rather than sit idle, may be used as a fleet vehicle by her organization and/or for personal use by other employees at the work site. Likewise, vehicle 1 might also be used by reverse commuters in the same fashion as vehicle 2. At the end of the work day, the cars migrate back to the station or parking lot and the users then utilize the vehicles for their return home. Many variations are possible. Altogether, a single shared-use vehicle could easily be used for six or more distinct trips per day, plus facilitating four or more additional transit trips.

The success of shared vehicle systems therefore depends on the reliable multiple use of the vehicles. In particular it is vital that there is a vehicle available at the end of the business day that can be used by the commuter to return home and complete the cycle. In U.S. Pat. No. 5,812,070, a shared vehicle rental system is disclosed which, inter allia, places vehicle users in two defined time slots as a means of allowing for the multiple use of shared vehicles. For example, the first group is composed of users commuting between their homes and a rental facility located near a transit station. The second group is composed of business entities located near the transit station that will use the vehicles for various business activities during the workday. The basis of coordinating the multiple use of the vehicles in the '070 patent is by defining time slots for each group. Group one is composed of 300 users with a usage time zone of after 5:00 p.m. and before 10:00 a.m. Group two is composed of 200 users with a usage time zone of 9:00 a.m. to 6:00 p.m. The disclosure, however, does not mention how vehicle monitoring could be used to create a more efficient allocation of vehicles. Instead, the disclosure simply relies on broad time slots and a larger proportionate of users in group one to help insure that a vehicle is available for use at any given time. Thus, a method of utilizing vehicle monitoring in a reservation system would be beneficial to a fleet operator by allowing the multiple use of the vehicles, while at the same time allowing users the security in knowing that a vehicle will be available at their request or return trip home.

### SUMMARY OF THE INVENTION

The primary object of the present invention is to provide a more efficient vehicle sharing system by providing a vehicle monitoring and reservation system which allows for a more accurate assessment of vehicle availability.

To achieve the above objective, a vehicle is monitored by determining its actual location and/or by taking advantage of user-input information regarding the vehicle's use, thereby providing an accurate assessment of the vehicle's availability for reallocation to the next user. The system is based on the premise that an efficient allocation of vehicles would create a situation where a majority of the vehicles in the fleet are used multiple times within a given day.

The present invention comprises a terminal for a user to request a vehicle, a fleet of vehicles for allocation, and parking facilities to obtain and return vehicles to. However, in order to more effectively make multiple use of vehicles within a shared vehicle system, the vehicle is monitored by the system using a tracking device and/or information submitted by the user regarding the use of the vehicle. A central computer processes the information, determines vehicle availability, and informs the user.

In particular embodiments of the invention, the vehicle monitoring means is a Global Positioning System (GPS) which comprises of a GPS receiver coupled to the vehicle so that the current ground position of the vehicle can be determined and processed by a central computer. Preferably, the monitoring of the vehicle is continuous and the information is relayed to the user via the central computer in real time.

In other embodiments, the invention makes use of geo-fencing as the means for vehicle monitoring. In one embodiment, the geo-fencing surrounds at least one parking area whereby the vehicles within, entering, or exiting can be tracked and monitored by the central computer. The parking area may be, and not by limitation, a transit station or work site parking facility. In another embodiment of the invention, geo-fencing of various radii is used to more accurately determine when a vehicle is either approaching or leaving a defined parking area by providing more data points for the central computer to process.

In yet another embodiment of the invention, the vehicle monitoring means is the user-input information submitted by the user when the vehicle is initially hired for use. User-input information may comprise either information concerning the user's past usage or information regarding the user's intended use of the vehicle. Past usage information can be ascertained by the central computer through means of recording the user's past usage information, storing the information, and recalling the information when the user enters an identification device such as a personal identification number, key fob, password, or identification card at a terminal when the vehicle is initially hired. User-input information could also include information that was initially submitted by the user during the registration process. The user's intended use of the vehicle may be information concerning their intended destination and/or duration of use. For example, a user hiring a vehicle at a work site parking area could enter the expected time the trip would take to run the errand and return to the parking area. By informing the central computer of the user's intended duration, the computer can monitor when the vehicle would be due to return and be available for reallocation. Likewise, once a user has registered, the user's destination would be known by the central computer and used to approximate when that vehicle would be available at the expected destination.

The present invention allows for the efficient allocation of vehicles by employing various vehicle monitoring means. The ability of the central computer to monitor or track the vehicles allows the system to more accurately predict when a given vehicle will be available for reallocation. For example, when a user swipes a key fob with its identification means on a vehicle mounted terminal, the central computer is informed of the user's registration information which may include information concerning the user's destination. This information is used by the central computer to determine when the vehicle will reach the destination and be available for reallocation. The data that the central computer uses to predict when the vehicle will be available for the next user can be supplemented by additional information when the user begins to enter a parking area surrounded by geo-fencing. This additional information increases the predictability of the system by employing an additional vehicle monitoring means usable by the central computer. Accuracy of the system is increased further by using a GPS means, whereby the location of the vehicle can be tracked continuously, processed by the central computer, and used by the user to gage in real time when a vehicle will be available for hire.

Whether the vehicle monitoring and reservation system employs all or just one of the monitoring means, the invention takes an active approach in increasing the number of vehicles that are, at any given time, not only presently available for allocation, but also determines when a vehicle will be available for allocation.

The above and other objects, features, and advantages of the present invention will become apparent from the following description when taken in conjunction with the accompanying drawings which illustrate a preferred embodiment of the invention by way of example.

### BRIEF DESCRIPTION OF THE DRAWINGS

FIG. 1 is a schematic showing a map of a geographical region which is combined with a vehicle monitoring system in shared vehicle system.

FIG. 2 is a flowchart depicting how a vehicle monitoring and reservation system is utilized in a vehicle sharing system.

### DETAILED DESCRIPTION OF THE PREFERRED EMBODIMENT

The present invention relates to vehicle monitoring and reservation system usable in a vehicle sharing system.

As indicated in the Background section above, the efficient allocation of vehicles from a shared fleet requires that the vehicles be allocated multiple times by various users. The vehicle monitoring means disclosed, when used in conjunction with a central computer that processes the information, creates a reservation system that more accurately predicts vehicle availability when vehicles are used multiple times. This vehicle monitoring and reservation system creates the advantageous situation whereby vehicles that once sat idle in work site parking lots or at transit stations are made available for reallocation. Reference will now be made in detail to the preferred embodiments of the invention, examples of which are illustrated in the accompanying drawings.

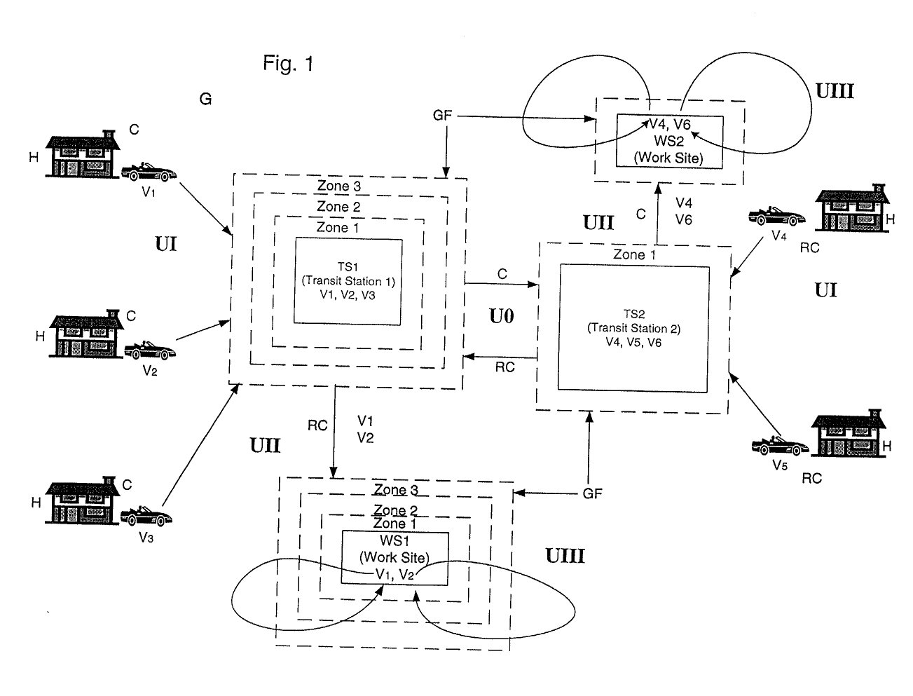

FIG. 1 is a schematic showing a map of a geographical region which is combined with a vehicle monitoring system in shared vehicle system. The geographical region G, is associated with a community of houses H, transit facilities TS1 and TS2, and work sites WS1 and WS2. Each transit station and work site includes a parking area with which to hire and return vehicles thereto. Users of the vehicle sharing system make use of a plurality of vehicles V1-V6. Users are categorized, simply for the basis of explanation, as commuters C and reverse commuters RC.

As shown in FIG. 1, vehicles V are used multiple times by various users. Based on the present example, Commuter C hires vehicles V1 at home H and drives it to a nearby transit station for the first usage of the vehicle UI. At transit station 1 TS1 commuter C leaves the vehicle at the designated parking area, the commuter C then takes the public transportation to transit station 2 TS2 located near the destination work site 2 WS2. No vehicle is used for this purpose U0. At transit station 2 TS2 vehicles have already been left at the transit station parking area by reverse commuters RC earlier that morning. Commuter C hires a vehicle V4 to reach the users intended work site destination. This would therefore constitute the vehicle's second usage UII. Commuter C then leaves the vehicle V4 at the work site 2 WS2 parking area and the vehicle V4 is then used by other users to engage in various business or personal activities which constitutes the vehicle's third usage UIII. The process is then reversed and, by the end of the day, a single vehicle may be used as six to seven times.

In addition, FIG. 1 shows the various vehicle monitoring means that are used to track the vehicles in the present system. The vehicle monitoring means of a Global Positioning System (GPS), geo-fencing, and user-input information, either by themselves or in conjunction, work to increase the reservation capabilities of the system by allowing the central computer to process such tracking information and provide for a more accurate assessment of vehicle availability.

A GPS is an accurate, three-dimensional navigation system that relies on a constellation of satellites that orbit the earth at an altitude of nearly 11,000 miles. The orbits of the satellites enable any GPS receiver near the surface of the earth to receive signals from at least three satellites to determine the receiver's precise global positions. A major benefit of the GPS is that the number of users is unlimited because the receivers passively acquire the signals transmitted by the satellites, which allows for broad commercial application. Vehicle tracking using GPS is well known in the art and is employed in the present invention to allow the central computer to accurately assess when a vehicle will arrive a given destination and be available for reallocation.

Geo-fencing is an electronic net that incorporates the technology of a GPS and can be used to detect when a vehicle is either entering, exiting, or contained within a designated area. For example, in FIG. 1, each transit station and work site parking area is enclosed using the vehicle monitoring means of geo-fencing GF, with transit station 1 TS1 and work site 1 WS1 employing the use of geo-fencing of various radii (zones 1-3) to enclose each parking area. The use of geo-fencing of various radii provides the vehicle monitoring and reservation system a more accurate means of tracking a vehicle than a single geo-fenced enclosed parking area by generating more data points for the central computer to process.

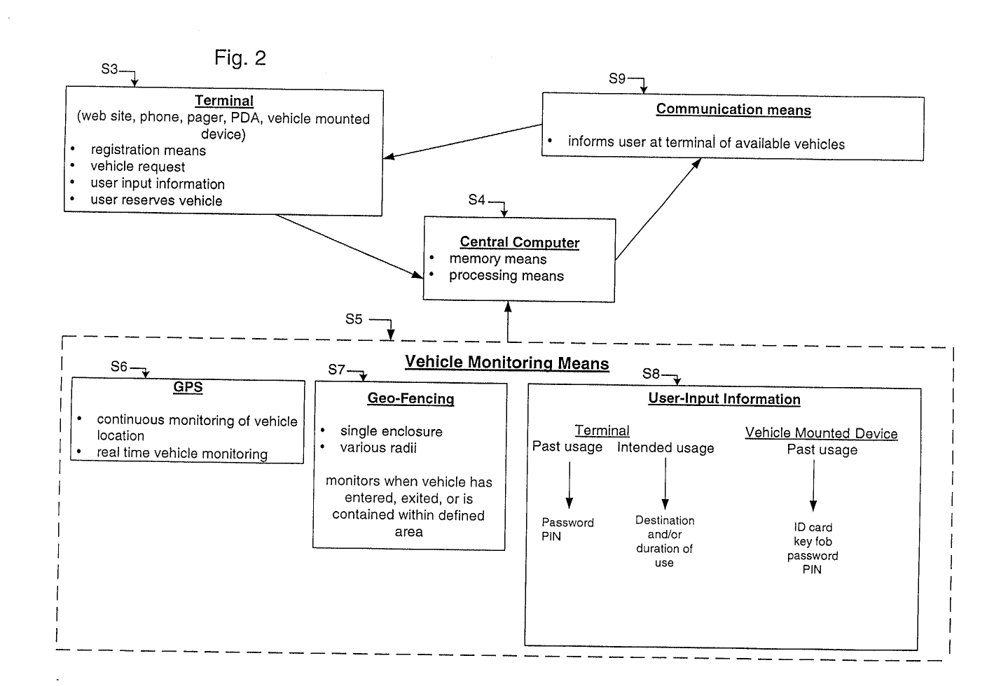

User-input information S8, as shown in FIG. 2, is also used as a means of monitoring a vehicle and determining when it may be available for reallocation. User-input information comprises information regarding the user's past vehicle usage or intended vehicle usage. The user's intended use of the vehicle may be information concerning their intended destination and/or duration of use. For example, a user hiring a vehicle at a work site parking area could enter the expected time the trip would take to run the errand and return to the parking area. By informing the central computer of the user's intended duration through the use of a terminal S3, the computer can monitor when the vehicle would be due to return and be available for reallocation. Likewise, once a user has registered, the user's destination would be known by the central computer and used to approximate when that vehicle would be available at the expected destination.

Past usage information can be ascertained by the central computer S4 through means of recording the user's past usage information, storing the information, and recalling the information S8 when the user enters an identification device such as a personal identification number, key fob, password, or identification card at a terminal when the vehicle is initially hired. In addition, when a user swipes a key fob with its identification means on a vehicle mounted terminal, the central computer is informed of the user's registration information which may include information concerning the user's destination. This information is used by the central computer to determine when the vehicle will reach the destination and be available for reallocation.

FIG. 2 shows how a vehicle monitoring and reservation system is utilized in a vehicle sharing system. A terminal S3 comprising a website, phone, or pager is used to receive registration information, a vehicle request, reserve a vehicle and input information regarding the user's intended vehicle usage, including the intended destination and/or duration of use. Registration information may include the user's intended destination, which is recalled when a user identification device such as an ID card, key fob password, or PIN is submitted via a vehicle mounted device.

A central computer S4 has memory sufficient to recognize user registration information and is able to process vehicle monitoring means S5 which includes GPS S6, geo-fencing S7, and user-input information S8 in order to accurately determine when the vehicle will reach the destination and be available for reallocation. After this is ascertained, the central computer S4 informs the user at terminal S3 via communication means S9, which is carried out by a communication installation for transmitting signals to and receiving signals using common forms of wired and wireless terminals S3. Once received by the user at a terminal S3, users can reserve a vehicle for use.

Although a certain preferred embodiment of the present invention has been shown and described in detail, it should be understood that various changes and modifications may be made therein without departing from the scope of the appended claims.

What is claimed is:

1. A vehicle monitoring and reservation system usable in a vehicle sharing system, comprising:
a) a terminal for accepting a request to use a vehicle;
b) registering means for registering said users;
c) vehicle monitoring means to monitor the use of a vehicle;
d) a parking area for a plurality of users to obtain vehicles from and return vehicles thereto;
e) a central computer with computing means responsive to said monitoring means for determining when a vehicle will be available for use at said parking area and memory means for storing registration information of said users from said registering means;
f) communication means responsive to said computing means for communicating the availability of said vehicles; and
g) an information device responsive to said communications means wherein the user is informed of the availability of said vehicles at said parking area and reserves an available vehicle.

2. The vehicle monitoring and reservation system of claim 1 wherein the vehicle monitoring means comprises a GPS receiver means for receiving radio signals from a GPS which indicates the current ground position of a GPS receiver, whereby the current ground position is also the vehicle's current location when the GPS receiver is coupled thereto.

3. The vehicle monitoring and reservation system of claim 1, wherein the terminal for accepting a user request is selected from a group comprising a web site, pager, telephone, or PDA.

4. The vehicle monitoring and reservation system of claim 1, wherein the information device is selected from a group comprising a web site, pager, telephone, or PDA.

5. The vehicle monitoring and reservation system of claim 2, wherein said communication means communicates the current ground position continuously.

6. The vehicle monitoring and reservation system of claim 1, wherein the vehicle monitoring means comprises geo-fencing means surrounding said parking area, whereby vehicles contained within, entering, or exiting the parking area can be tracked and accounted for.

7. The vehicle monitoring and reservation system of claim 1 wherein the vehicle monitoring means comprises geo-fencing means of various radii surrounding said parking area, whereby vehicles contained within, entering, or exiting the parking area can be tracked and accounted for.

8. The vehicle monitoring and reservation system of claim 3, wherein the terminal further comprises means for receiving user-input information.

9. The vehicle monitoring and reservation system of claim 8 wherein the vehicle monitoring means comprises user-input information submitted by the user at said terminal.

10. The vehicle monitoring and reservation system of claim 9, wherein the user-input information comprises information regarding the user's average past vehicle usage.

11. The vehicle monitoring and reservation system of claim 9, wherein user-input information comprises information regarding the user's intended destination.

12. The vehicle monitoring and reservation system of claim 9, wherein user-input information comprises information regarding the user's intended duration of use.

13. The vehicle monitoring and reservation system of claim 9, wherein user-input information comprises information regarding the user's intended destination and duration of use.

14. The vehicle monitoring and reservation system of claim 10, wherein the user-input information is recalled by the central computer's memory means when the registered user's personal identification number or password is inputted in said terminal.

15. The vehicle monitoring and reservation system of claim 9, wherein the terminal for receiving user-input information is a vehicle mounted device.

16. The vehicle monitoring and reservation system of claim 15, wherein the user-input information is contained on a device selected from a group comprising a key fob, personal identification number, or identification card.

17. The vehicle monitoring and reservation system of claim 16, wherein the user-input information comprises information regarding the user's average past vehicle usage.

18. A vehicle monitoring and reservation system usable in a vehicle sharing system, comprising:
a) a terminal for accepting a request to use a vehicle and user input information;
b) registering means for registering said users;
c) vehicle monitoring means to monitor the use of a vehicle;
d) a parking area for a plurality of users to obtain vehicles from and return vehicles thereto;
e) a central computer with computing means responsive to said monitoring means for determining when a vehicle will be available for use at said parking area and memory means for storing registration information of said users from said registering means;
f) communication means responsive to said computing means for communicating the availability of said vehicles; and
g) an information device responsive to said communications means wherein the user is informed of the availability of said vehicles at said parking area and reserves an available vehicle.

19. The vehicle monitoring and reservation system of claim 18, wherein the vehicle monitoring means comprises:
a) geo-fencing means surrounding said parking area, whereby vehicles contained within, entering, or exiting the parking area can be tracked and accounted for; and
b) user-input information.

20. The vehicle monitoring and reservation system of claim 18, wherein the vehicle monitoring means comprises:
a) geo-fencing means of various radii surrounding said parking area, whereby vehicles contained within, entering, or exiting the parking area can be tracked and accounted for; and
b) user-input information.

21. The vehicle monitoring and reservation system of claim 18, wherein the vehicle monitoring means comprises:
a) geo-fencing means surrounding said parking area, whereby vehicles contained within, entering, or exiting the parking area can be tracked and accounted for;
b) geo-fencing means of various radii surrounding said parking area, whereby vehicles contained within, entering, or exiting the parking area can be tracked and accounted for; and
c) user-input information.
